(19) United States
(12) Patent Application Publication
(10) Pub. No.: US 2019/0245190 A1
(43) Pub. Date: Aug. 8, 2019

(54) STACKED BATTERY

(71) Applicant: TOYOTA JIDOSHA KABUSHIKI KAISHA, Toyota-shi (JP)

(72) Inventors: Hideaki WATANABE, Nisshin-shi (JP); Masaharu Senoue, Seto-shi (JP); Hajime Hasegawa, Susono-shi (JP); Norihiro Ose, Sunto-gun (JP); Hideaki Nishimura, Sunto-gun (JP)

(73) Assignee: TOYOTA JIDOSHA KABUSHIKI KAISHA, Toyota-shi (JP)

(21) Appl. No.: 16/260,492

(22) Filed: Jan. 29, 2019

(30) Foreign Application Priority Data
Feb. 6, 2018 (JP) 2018-019515
Apr. 25, 2018 (JP) 2018-084425

(51) Int. Cl. H01M 2/34; H01M 10/04; H01M 10/0525; H01M 10/0585; H01M 10/0562; H01M 4/66

(52) U.S. Cl. CPC H01M 2/34; H01M 10/0413; H01M 10/0525; H01M 2200/00; H01M 10/0562; H01M 4/661; H01M 2300/0068; H01M 10/0585

(57) ABSTRACT

To stabilize shunt resistance of a short-circuit current shunt part when the short-circuit current shunt part short-circuits due to nail penetration etc. in a stacked battery including the short-circuit current shunt part, the stacked battery includes: at least one short-circuit current shunt part; and at least one electric element, the short-circuit current shunt part and the electric element being stacked, wherein the short-circuit current shunt part includes a first current collector layer, a second current collector layer, and an insulating layer provided between the first and second current collector layers, all of these layers being layered, the electric element includes a cathode current collector layer, a cathode material layer, an electrolyte layer, an anode material layer, and an anode current collector layer, all of these layers being layered, the first current collector layer is electrically connected with the cathode current collector layer, the second current collector layer is electrically connected with the anode current collector layer, and each of the first and second current collector layers consists of at least one metal selected from the group consisting of copper, stainless steel, nickel, iron, chromium, and titanium.

### FIELD

The present application discloses a stacked battery.

### BACKGROUND

Nail penetration testing is known as testing for evaluating safety when a battery is broken from the outside. Nail penetration testing is such testing that a conductive nail is run to penetrate through a battery, and a temperature increase etc. in short circuits in an electric element are observed. Patent Literature 1 discloses a battery comprising a protection component that includes two insulating layers and a conducting layer disposed between these two insulating layers, and is provided outside an electric element. In Patent Literature 1, the protection component functions as a preceding short circuit layer in nail penetration testing. That is, the protection component is short-circuited prior to the electric element in nail penetration testing, to make discharge of the electric element progress before the electric element short-circuits, which suppresses a temperature increase inside the electric element.

### CITATION LIST

### Patent Literature

Patent Literature 1: JP 6027262 B2

### SUMMARY

### Technical Problem

In view of the technique disclosed in Patent Literature 1, it is believed that in a battery, a short-circuit current shunt part (a part that causes a short-circuit current to divide and flow thereinto when an electric element and the short-circuit current shunt part short-circuit) having a conducting layer and an insulating layer is provided separately from an electric element, and the short-circuit current shunt part is short-circuited first in nail penetration, which can make current (rounding current) from the electric element flow into the short-circuit current shunt part, to make discharge of the electric element progress, which makes it possible to suppress heat generation inside the electric element (FIG. 5A). In this case, it is necessary to keep a short-circuiting state (stably low shunt resistance) in the short-circuit current shunt part in nail penetration.

Such a problem is especially easy to arise in a stacked battery including a plurality of stacked electric elements electrically connected in parallel that when nail penetration short-circuits some electric elements, electrons flow from some electric elements into the other electric elements, which results in a local temperature increase in some electric elements. For this, it is believed that a short-circuit current shunt part is provided separately from electric elements, and not only some electric elements but also the short-circuit current shunt part is short-circuited in nail penetration testing, to shunt a rounding current from the electric elements of a higher shunt resistance to not only the electric elements of a lower shunt resistance but also the short-circuit current shunt part of a low shunt resistance, which can prevent only the temperature of some electric elements from locally increasing (FIG. 5B). Also in this case, it is necessary to keep a short-circuiting state in the short-circuit current shunt part in nail penetration.

For example, a short-circuit current shunt part can be composed of a first current collector layer, a second current collector layer, and an insulating layer that is provided between them. As disclosed in Patent Literature 1, the insulating layer can be formed using any resin. Or, the insulating layer can be formed using a ceramic material and/or a battery separator. In contrast, the first and second current collector layers can be formed of metal foil as disclosed in Patent Literature 1. Whereby it is believed that the first current collector layer can be insulated from the second current collector layer by the insulating layer in normal use, and the first and second current collector layers can be in contact to short-circuit the short-circuit current shunt part in nail penetration.

However, the inventors of the present application encountered such a new problem that a shunt resistance of a short-circuit current shunt part is sometimes unstable in nail penetration when the short-circuit current shunt part is made with reference to the technique disclosed in Patent Literature 1 etc. An unstable shunt resistance of the short-circuit current shunt part may make it impossible to efficiently make current from an electric element flow into the short-circuit current shunt part, and to suppress Joule heating in the electric element.

### Solution to Problem

The present application discloses, as one means for solving the problem, a stacked battery comprising: at least one short-circuit current shunt part; and at least one electric element, the short-circuit current shunt part and the electric element being stacked, wherein the short-circuit current shunt part comprises a first current collector layer, a second current collector layer, and an insulating layer provided between the first and second current collector layers, all of these layers being layered, the electric element comprises a cathode current collector layer, a cathode material layer, an electrolyte layer, an anode material layer, and an anode current collector layer, all of these layers being layered, the first current collector layer is electrically connected with the cathode current collector layer, the second current collector layer is electrically connected with the anode current collector layer, and each of the first and second current collector layers consists of at least one metal selected from the group consisting of copper, stainless steel, nickel, iron, chromium, and titanium.

In the stacked battery of this disclosure, preferably, a plurality of the electric elements are electrically connected with each other in parallel.

Preferably, the stacked battery of this disclosure further comprising: an external case that stores the short-circuit current shunt part and the electric element, wherein the short-circuit current shunt part is provided between the electric element and the external case.

In the stacked battery of this disclosure, preferably, the following directions are the same: a direction of layering the cathode current collector layer, the cathode material layer, the electrolyte layer, the anode material layer, and the anode current collector layer in the electric element; a direction of layering the first current collector layer, the insulating layer, and the second current collector layer in the short-circuit current shunt part; and a direction of stacking the short-circuit current shunt part and the electric element.

In the stacked battery of this disclosure, the electrolyte layer is preferably a solid electrolyte layer.

In the stacked battery of this disclosure, each of the first and second current collector layers preferably consists of copper.

In the stacked battery of this disclosure, preferably, the cathode current collector layer consists of aluminum, and the anode current collector layer consists of copper.

In the stacked battery of this disclosure, at least one of the first and second current collector layers preferably consists of a plurality of sheets of metal foil. In this case, the metal foil is especially preferably copper foil.

### Advantageous Effects

According to the findings of the inventors of the present application, when a short-circuit current shunt part is made with reference to the technique disclosed in Patent Literature 1, contact of first and second current collector layers is not stably kept when a nail penetrates through the short-circuit current shunt part, which makes a shunt resistance unstable. The reason why the contact of the first and second current collector layers is not stably kept when a nail penetrates through the short-circuit current shunt part is predicted to be because of melt-cutting of the current collector layers of the short-circuit current shunt part due to Joule heating caused by current flowing into the short-circuit current shunt part. Therefore, for stably keeping the contact of the first and second current collector layers when a nail penetrates through the short-circuit current shunt part, it is believed to be effective to prevent melt-cutting of the first and second current collector layers due to Joule heating in nail penetration.

In the stacked battery of this disclosure, both first and second current collector layers composing a short-circuit current shunt part are formed of a predetermined metal of a high melting point. Whereby, melt-cutting of the first and second current collector layers due to Joule heating can be prevented, and the contact property of the first and second current collector layers etc. are improved. That is, according to the stacked battery of this disclosure, the shunt resistance of the short-circuit current shunt part in nail penetration through the short-circuit current shunt part can be stabilized.

### BRIEF DESCRIPTION OF DRAWINGS

FIG. 1 is an explanatory schematic view of structure of layers of a stacked battery 100;

FIGS. 2A and 2B are explanatory schematic views of structure of layers of a short-circuit current shunt part 10; FIG. 2A is an external perspective view and FIG. 2B is a cross-sectional view taken along the line IIB-IIB;

FIGS. 3A and 3B are explanatory schematic views of structure of layers of electric elements 20; FIG. 3A is an external perspective view and FIG. 3B is a cross-sectional view taken along the line IIIB-IIIB;

FIG. 4 is an explanatory schematic view of a way of nail penetration testing on a short-circuit current shunt part; and

FIGS. 5A and 5B are explanatory schematic views of, for example, a rounding current generated in nail penetration in a stacked battery.

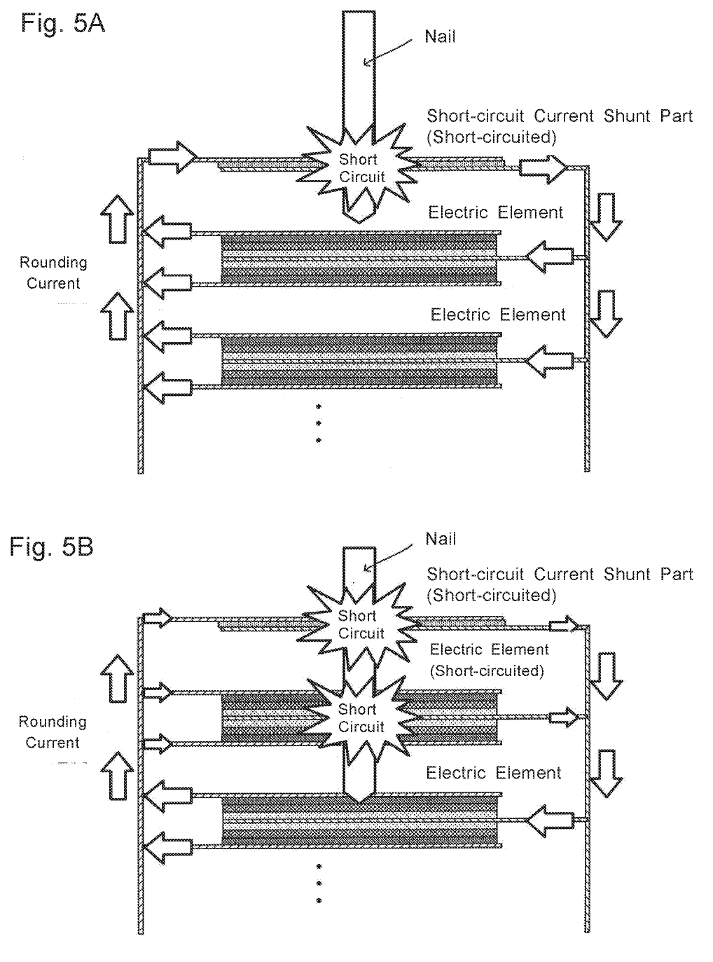

### DETAILED DESCRIPTION OF EMBODIMENTS

1. Stacked Battery 100

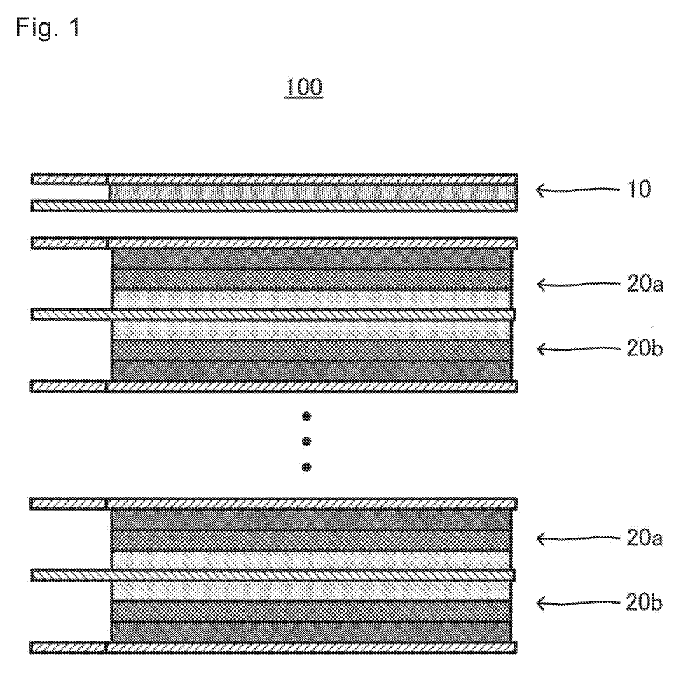

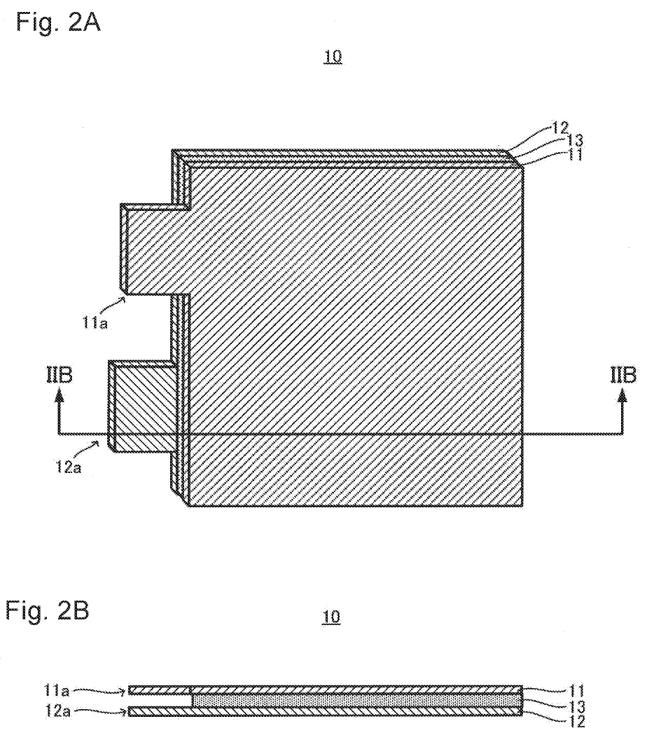

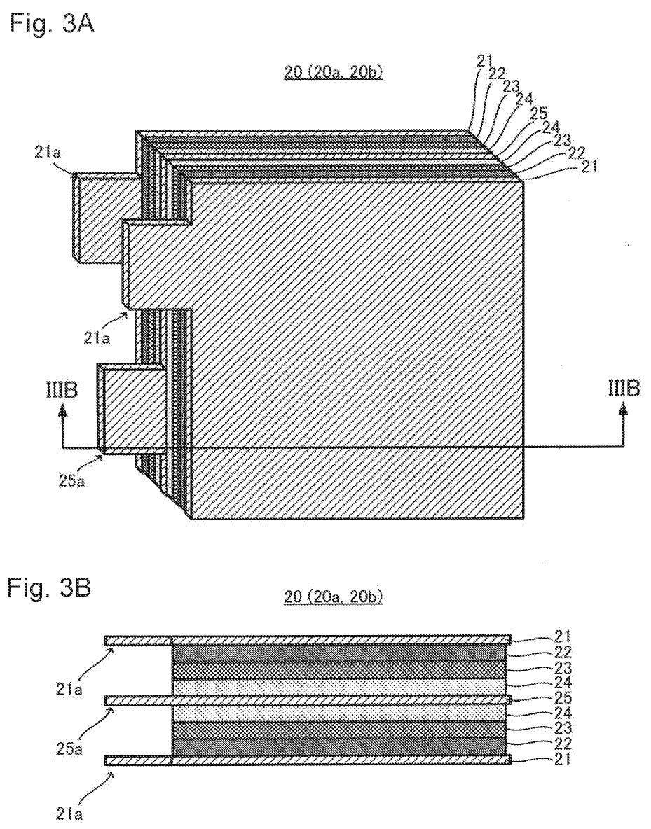

FIG. 1 schematically shows structure of layers of a stacked battery 100. In FIG. 1, portions where current collector layers (current collector tabs) are connected to each other, a battery case, etc. are omitted for convenient explanation. FIGS. 2A and 2B schematically show the structure of the layers of a short-circuit current shunt part 10 that is a component of the stacked battery 100. FIG. 2A is an external perspective view and FIG. 2B is a cross-sectional view taken along the line IIB-IIB. FIGS. 3A and 3B schematically show the structure of the layers of electric elements 20 that are components of the stacked battery 100. FIG. 3A is an external perspective view and FIG. 3B is a cross-sectional view taken along the line IIIB-IIIB.

As shown in FIGS. 1 to 3B, at least one short-circuit current shunt part 10 and at least one electric element 20 (electric elements 20a and 20b) are stacked, to form the stacked battery 100. In the short-circuit current shunt part 10, a first current collector layer 11, a second current collector layer 12, and an insulating layer 13 that is provided between the first current collector layer 11 and the second current collector layer 12 are layered. In each of the electric elements 20a and 20b, a cathode current collector layer 21, a cathode material layer 22, a solid electrolyte layer 23, an anode material layer 24, and an anode current collector layer 25 are layered. In the stacked battery 100, the first current collector layer 11 is electrically connected with the cathode current collector layer 21, and the second current collector layer 12 is electrically connected with the anode current collector layer 25. Here, a feature of the stacked battery 100 is that each of the first current collector layer 11 and the second current collector layer 12 consists of at least one metal selected from the group consisting of copper, stainless steel, nickel, iron, chromium, and titanium.

1.1. Short-Circuit Current Shunt Part 10

The short-circuit current shunt part 10 includes the first current collector layer 11, the second current collector layer 12, and the insulating layer 13 that is provided between the first current collector layer 11 and the second current collector layer 12. In the short-circuit current shunt part 10 having such structure, while the first current collector layer 11 is properly insulated from the second current collector layer 12 via the insulating layer 13 when the battery is normally used, the first current collector layer 11 and the second current collector layer 12 are in contact in nail penetration, which leads to a low electric resistance.

1.1.1. First Current Collector Layer 11 and Second Current Collector 12

The first current collector layer 11 and the second current collector layer 12 may be formed of metal foil, a metal mesh, etc., and are especially preferably formed of metal foil. Here, it is important that each of the first current collector layer 11 and the second current collector layer 12 consists of at least one metal selected from the group consisting of copper, stainless steel, nickel, iron, chromium, and titanium. The first current collector layer 11 and the second current collector layer 12 especially preferably consist of copper. All these metals have a high melting point of no less than 1000° C., and have sufficient electron conductivity. Making the first current collector layer 11 and the second current collector layer 12 from such metal of a high melting point makes it possible to prevent melt-cutting due to Joule heating in short circuits in nail penetration testing etc. The first current collector layer 11 and the second current collector layer 12 may have some layer for adjusting a contact resistance, over their surfaces. The first current collector layer 11 and the second current collector layer 12 may be formed of the same metal, and may be formed of different metals from each other.

Each thickness of the first current collector layer 11 and the second current collector layer 12 is not specifically limited and for example, is preferably 0.1 μm to 1 mm, and is more preferably 1 μm to 100 μm. Each thickness thereof within such a range makes it possible to contact the current collector layers 11 and 12 each other more properly in nail penetration, and to more properly short-circuit the short-circuit current shunt part 10.

In the short-circuit current shunt part 10, at least one of the first current collector layer 11 and the second current collector layer 12 is preferably composed of a plurality of sheets of metal foil, and both of the first current collector layer 11 and the second current collector layer 12 are especially preferably composed of a plurality of sheets of metal foil. For example, a plurality of sheets of metal foil are layered to be (a) laminate(s), to be used as the first current collector layer 11 and/or the second current collector layer 12. Here, a direction of layering a plurality of sheets of the metal foil is preferably the same as that of layering the first current collector layer 11, the insulating layer 13, and the second current collector layer 12 in the short-circuit current shunt part 10. Making the first current collector layer 11 and/or the second current collector layer 12 from a plurality of sheets of the metal foil makes it possible to improve the contact property of the first current collector layer 11 and the second current collector layer 12 in nail penetration testing, and to more stably short-circuit the short-circuit current shunt part 10. Metal constituting the metal foil may be at least one metal selected from the group consisting of copper, stainless steel, nickel, iron, chromium, and titanium as described above. Among them, the metal foil is especially preferably copper foil.

As shown in FIGS. 2A and 2B, the first current collector layer 11 includes a current collector tab 11a, and is preferably connected to the cathode current collector layers 21 of the electric elements 20 electrically via the current collector tab 11a. On the other hand, the second current collector layer 12 includes a current collector tab 12a, and is preferably connected to the anode current collector layers 25 of the electric elements 20 electrically via the current collector tab 12a. The current collector tab 11a may be formed of either the same material as, or a different material from the first current collector layer 11. The current collector tab 12a may be formed of either the same material as, or a different material from the second current collector layer 12.

1.1.2. Insulating Layer 13

In the stacked battery 100, the insulating layer 13 may insulate the first current collector layer 11 from the second current collector layer 12 when the battery is normally used. The insulating layer 13 may be an insulating layer constituted of an organic material, may be an insulating layer constituted of an inorganic material, and may be an insulating layer where organic and inorganic materials coexist. Specifically, an insulating layer constituted of an organic material is preferable because being advantageous compared with that constituted of an inorganic material in view of a low probability of occurrence of short circuits due to cracking in normal use.

Examples of an organic material that may constitute the insulating layer 13 include various resins such as various thermoplastic resins and various thermosetting resins. Specifically, a super engineering plastic such as polyimide, polyamide-imide, polyether ether ketone, and polyphenylene sulfide is preferable. Generally, a thermosetting resin has better thermal stability than a thermoplastic resin, and is hard and brittle. That is, when constituted of a thermosetting resin, the insulating layer 13 easily breaks when a nail penetrates through the short-circuit current shunt part 10, which makes it possible to suppress the insulating layer 13 from following deformation of the first current collector layer 11 and the second current collector layer 12, to more easily contact the first current collector layer 11 and the second current collector layer 12. In addition, even if the temperature of the insulating layer 13 rises, thermal decomposition can be suppressed. In view of this, the insulating layer 13 is preferably composed of a thermosetting resin sheet, and more preferably composed of a thermosetting polyimide resin sheet.

Examples of an inorganic material that may constitute the insulating layer 13 include various ceramics such as inorganic oxides. The insulating layer 13 may be composed of metal foil that has oxide coating over its surface. For example, aluminum foil that has coating of aluminum oxide as an insulating layer over its surface is obtained by anodizing aluminum foil to form anodic oxide coating over its surface. In this case, the thickness of the coating of aluminum oxide is preferably 0.01 μm to 5 μm. The lower limit is more preferably no less than 0.1 μm, and the upper limit is more preferably no more than 1 μm.

The thickness of the insulating layer 13 is not specifically limited, and for example, is preferably 0.1 μm to 1 mm, and is more preferably 1 μm to 100 μm. The thickness of the insulating layer 13 within such a range makes it possible to more properly insulate the first current collector layer 11 from the second current collector layer 12 when the battery is normally used, and can lead to more proper continuity between the first current collector layer 11 and the second current collector layer 12 according to deformation due to external stress such as nail penetration, to short-circuit the short-circuit current shunt part 10.

1.2. Electric Elements 20 (20a and 20b)

In the stacked battery 100, the cathode current collector layer 21, the cathode material layer 22, the solid electrolyte layer 23, the anode material layer 24, and the anode current collector layer 25 are layered to form each of the electric elements 20a and 20b. That is, the electric elements 20a and 20b can individually function as a single cell.

1.2.1. Cathode Current Collector Layer 21

The cathode current collector layer 21 may be formed of metal foil, a metal mesh, etc., and is especially preferably formed of metal foil. Examples of metal that constitutes the cathode current collector layer 21 include Ni, Cr, Au, Pt, Al, Fe, Ti, Zn and stainless steel. The cathode current collector layer 21 is especially preferably formed of Al, which has high electric conductivity, in view of output performance. The cathode current collector layer 21 may have some coating layer for adjusting a contact resistance, over its surface, which is, for example, a coating layer containing a conductive material and resin. The thickness of the cathode current collector layer 21 is not limited, and for example, is preferably 0.1 μm to 1 mm, and is more preferably 1 μm to 100 μm.

As shown in FIGS. 3A and 3B, the cathode current collector layer 21 preferably includes a cathode current collector tab 21a at part of an outer edge thereof. The tab 21a makes it possible to electrically connect the first current collector layer 11 and the cathode current collector layer 21 easily, and to electrically connect the cathode current collector layers 21 to each other easily in parallel.

1.2.2. Cathode Material Layer 22

The cathode material layer 22 is a layer containing at least an active material. When the stacked battery 100 is an all-solid state battery, the cathode material layer 22 may further contain a solid electrolyte, a binder, a conductive additive, etc. optionally, in addition to an active material. When the stacked battery 100 is a battery of an electrolyte solution system, the cathode material layer 22 may further contain a binder, a conductive additive, etc. optionally, in addition to an active material. A known active material may be used. One may select two materials different in electric potential at which predetermined ions are stored/released (charge/discharge potential) among known active materials, to use a material displaying a noble potential as a cathode active material, and a material displaying a base potential as an anode active material described later. For example, when a lithium ion battery is made, any lithium containing composite oxide such as lithium cobaltate, lithium nickelate, LiNi_{1/3}Co_{1/3}Mn_{1/3}O₂, lithium manganate, and a spinel lithium compound may be used as the cathode active material. When the stacked battery 100 is an all-solid state battery, the surface of the cathode active material may be coated with an oxide layer such as a lithium niobate layer, a lithium titanate layer, and a lithium phosphate layer. When the stacked battery 100 is an all-solid state battery, the solid electrolyte is preferably an inorganic solid electrolyte because ion conductivity is high compared with an organic polymer electrolyte. This is also because an inorganic solid electrolyte has a good heat resistance compared with an organic polymer electrolyte. This is moreover because pressure applied to the electric elements 20 in nail penetration is high compared to the case using an organic polymer electrolyte, which makes the effect of the stacked battery 100 of the present disclosure outstanding. Preferred examples of an inorganic solid electrolyte include oxide solid electrolytes such as lithium lanthanum zirconate, LiPON, Li_{1+X}Al_{X}Ge_{2-X}(PO₄)₃, Li—SiO based glass, and Li—Al—S—O based glass; and sulfide solid electrolytes such as Li₂S—P₂S₅, Li₂S—S₁S₂, LiI—Li₂S—S₁S₂, LiI—Si₂S—P₂S₅, LiI—LiBr—Li₂S—P₂S₅, LiI—Li₂S—P₂S₅, LiI—Li₂S—P₂O₅, LiI—Li₃PO₄—P₂S₅, and Li₂S—P₂S₅—GeS₂. Especially, a sulfide solid electrolyte containing Li₂S—P₂S₅ is more preferable, and a sulfide solid electrolyte containing no less than 50 mol % of Li₂S—P₂S₅ is further preferable. Examples of a binder that may be contained in the cathode material layer 22 include butadiene rubber (BR), acrylate-butadiene rubber (ABR), and polyvinylidene difluoride (PVdF). Examples of a conductive additive that may be contained in the cathode material layer 22 include carbon materials such as acetylene black and Ketjenblack, and metallic materials such as nickel, aluminum, and stainless steel. The contents of the constituents in the cathode material layer 22 may be the same as in a conventional one. The shape of the cathode material layer 22 may be the same as a conventional one as well. Specifically, from the viewpoint that the stacked battery 100 can be easily made, the cathode material layer 22 in the form of a sheet is preferable. In this case, the thickness of the cathode material layer 22 is, for example, preferably 0.1 μm to 1 mm, and more preferably 1 μm to 150 μm.

1.2.3. Electrolyte Layer 23

The electrolyte layer 23 is a layer containing at least an electrolyte. When the stacked battery 100 is an all-solid state battery, the electrolyte layer 23 may be a solid electrolyte layer containing a solid electrolyte, and optionally a binder. The solid electrolyte is preferably an inorganic solid electrolyte described above. The binder same as one used in the cathode material layer 22 may be properly selected to be used. The contents of the constituents in the solid electrolyte layer 23 may be the same as in a conventional one. The shape of the solid electrolyte layer 23 may be the same as a conventional one as well. Specifically, from the viewpoint that the stacked battery 100 can be easily made, the solid electrolyte layer 23 in the form of a sheet is preferable. In this case, the thickness of the solid electrolyte layer 23 is, for example, preferably 0.1 μm to 1 mm, and more preferably 1 μm to 100 μm. On the other hand, when the stacked battery 100 is a battery of an electrolyte solution system, the electrolyte layer 23 contains an electrolyte solution, and a separator. These electrolyte solution and separator are obvious for the person skilled in the art, and thus detailed description thereof is omitted here.

1.2.4. Anode Material Layer 24

The anode material layer 24 is a layer containing at least an active material. When the stacked battery 100 is an all-solid state battery, the anode material layer 24 may further contain a solid electrolyte, a binder, a conductive additive, etc. optionally, in addition to an active material. When the stacked battery 100 is a battery of an electrolyte solution system, the anode material layer 24 may further contain a binder, a conductive additive, etc. optionally, in addition to an active material. A known active material may be used. One may select two materials different in electric potential at which predetermined ions are stored/released (charge/discharge potential) among known active materials, to use a material displaying a noble potential as the cathode active material, and a material displaying a base potential as the anode active material. For example, when a lithium ion battery is made, Si or a Si alloy; a carbon material such as graphite and hard carbon; any oxide such as lithium titanate; lithium metal or a lithium alloy; or the like may be used as the anode active material. A solid electrolyte, a binder, and a conductive additive may be properly selected from ones that are the examples as those used in the cathode material layer 22, to be used. The contents of the constituents in the anode material layer 24 may be the same as in a conventional one. The shape of the anode material layer 24 may be the same as a conventional one as well. Specifically, from the viewpoint that the stacked battery 100 can be easily made, the anode material layer 24 in the form of a sheet is preferable. In this case, the thickness of the anode material layer 24 is, for example, preferably 0.1 μm to 1 mm, and more preferably 1 μm to 100 μm. The thickness of the anode material layer 24 is preferably determined so that the capacity of an anode is larger than that of a cathode.

1.2.5. Anode Current Collector Layer 25

The anode current collector layer 25 may be formed of metal foil, a metal mesh, etc., and is especially preferably formed of metal foil. Examples of metal that constitutes the anode current collector layer 25 include Cu, Ni, Fe, Ti, Co, Zn and stainless steel. The anode current collector layer 25 is especially preferably formed of Cu. The anode current collector layer 25 may have some coating layer for adjusting a contact resistance, over its surface, which is, for example, a coating layer containing a conductive material and resin. The thickness of the anode current collector layer 25 is not specifically limited, and for example, is preferably 0.1 μm to 1 mm, and is more preferably 1 μm to 100 μm.

As shown in FIGS. 3A and 3B, the anode current collector layer 25 preferably includes an anode current collector tab 25a at part of an outer edge thereof. The tab 25a makes it possible to electrically connect the second current collector layer 12 to the anode current collector layer 25 easily, and to electrically connect the anode current collector layers 25 to each other easily in parallel.

1.3. Arrangement and Connection Forms of Short-Circuit Current Shunt Part and Electric Element

1.3.1. Arrangement of Electric Element

In the stacked battery 100, the number of stacking the electric elements 20a and 20b is not specifically limited, and may be properly determined according to the power of the battery to be aimed. In this case, a plurality of the electric elements 20 may be stacked so as to be directly in contact with each other, or may be stacked via some layers (for example, insulating layers) or spaces (air spaces). In view of improving the power density of the battery, a plurality of the electric elements 20 are preferably stacked so as to be directly in contact with each other as shown in FIG. 1. As shown in FIGS. 1, 3A and 3B, two electric elements 20a and 20b preferably share the anode current collector 25, which further improves the power density of the battery. Further, as shown in FIG. 1, in the stacked battery 100, if a plurality of the electric elements are provided, a direction of stacking a plurality of the electric elements 20 is preferably the same as that of layering the layers 21 to 25 in the electric elements 20, which makes it easy to, for example, constrain the stacked battery 100, to further improve the power density of the battery.

1.3.2. Electric Connection of Electric Elements Each Other

As shown in FIG. 1, the stacked battery 100 preferably includes a plurality of the electric elements that are electrically connected to each other in parallel. In the electric elements connected in parallel as described above, when one electric element short-circuits, electrons concentratedly flow into the one electric element from the other electric elements. That is, Joule heating is easy to be high when the battery short-circuits. In other words, in the stacked battery 100 including a plurality of the electric elements 20 connected in parallel as described above, the effect of providing the short-circuit current shunt part 10 is more outstanding. On the other hand, the problem (melt-cutting of the first current collector layer 11 and the second current collector layer 12 due to Joule heating) is easy to arise. A conventionally known member may be used as a member for electrically connecting the electric elements to each other. For example, as described above, one may provide the cathode current collector tabs 21a for the cathode current collector layers 21, and the anode current collector tabs 25a for the anode current collector layers 25, to electrically connect the electric elements 20 to each other in parallel via the tabs 21a and 25a.

1.3.3. Electric Connection of Short-Circuit Current Shunt Part and Electric Element

In the stacked battery 100, the first current collector layer 11 of the short-circuit current shunt part 10 is electrically connected with the cathode current collector layers 21 of the electric elements 20, and the second current collector layer 12 of the short-circuit current shunt part 10 is electrically connected with the anode current collector layers 25 of the electric elements 20. Electric connection of the short-circuit current shunt part 10 and the electric elements 20 like this makes it possible to make a rounding current from the electric elements flow into the short-circuit current shunt part 10 when the short-circuit current shunt part 10 short-circuits. A conventionally known member may be used as a member for electrically connecting the short-circuit current shunt part 10 and the electric elements 20. For example, as described above, one may provide the first current collector tab 11a for the first current collector layer 11, and the second current collector tab 12a for the second current collector layer 12, to electrically connect the short-circuit current shunt part 10 and the electric elements 20 via the tabs 11a and 12a.

1.3.4. Positional Relationship Between Short-Circuit Current Shunt Part and Electric Element

The short-circuit current shunt part 10 and a plurality of the electric elements 20 may be stacked to each other. In this case, the short-circuit current shunt part 10 and a plurality of the electric elements 20 may be directly stacked, and may be indirectly stacked via other layers (insulating layers, heat insulating layers, etc.) as long as the problem can be solved. As described above, the short-circuit current shunt part 10 may be stacked on an outer side than a plurality of the electric elements 20, may be stacked between a plurality of the electric elements 20, and may be stacked both on an outer side than and between a plurality of the electric elements 20. Especially, as shown in FIG. 1, when the short-circuit current shunt part 10 and a plurality of the electric elements 20 are stacked, the short-circuit current shunt part 10 is preferably provided on an outer side than a plurality of the electric elements 20, and more preferably provided at least on an outer side than a plurality of the electric elements 20 with respect to the layering direction (direction of layering the layers in a plurality of the electric elements 20). In other words, in the stacked battery 100, if an external case (not shown) storing the short-circuit current shunt part 10 and the electric elements 20 is provided, at least one short-circuit current shunt part 10 is preferably provided between the electric elements 20 and the external case. Whereby in nail penetration, the short-circuit current shunt part 10 short-circuits prior to the electric element 20a etc., which makes it possible to generate a rounding current from the electric element 20a etc. to the short-circuit current shunt part 10, and further, to suppress heat generation inside the electric element 20a etc.

Short circuits of the battery due to nail penetration are easy to occur when a nail penetrates from the cathode current collector layer 21 toward the anode current collector layer 25 (or from the anode current collector layer 25 toward the cathode current collector layer 21) of the electric element 20a. In this point, in the stacked battery 100, a direction of nail penetration is preferably the same as that of layering the layers. More specifically, as shown in FIG. 1, the following directions are preferably the same: the direction of layering the cathode current collector layers 21, the cathode material layers 22, the solid electrolyte layers 23, the anode material layers 24, and the anode current collector layers 25 in the electric elements 20a and 20b; the direction of layering the first current collector layer 11, the insulating layer 13, and the second current collector layer 12 in the short-circuit current shunt part 10; and a direction of stacking the short-circuit current shunt part 10 and the electric elements 20.

1.3.5. Relationship Between Short-Circuit Current Shunt Part and Electric Element in Size

In the stacked battery 100, the short-circuit current shunt part 10 covers as much part of the electric elements 20 as possible, which makes it easy to short-circuit the short-circuit current shunt part 10 prior to the electric elements 20 in nail penetration. In view of this, for example, in the stacked battery 100, the outer edges of the short-circuit current shunt part 10 are preferably present on an outer side than those of the electric elements 20 when viewed in the direction of stacking the short circuit-current shunt part 10 and the electric elements 20. Alternatively, when the direction of stacking the short-circuit current shunt part 10 and the electric elements 20 is the same as that of layering the layers 21 to 25 in the electric elements 20, the outer edges of the short-circuit current shunt part 10 are preferably present on an outer side than those of the cathode material layers 22, the electrolyte layers 23, and the anode material layers 24 when viewed in the direction of stacking the short-circuit current shunt part 10 and the electric elements 20. In this case, preferably, the first current collector layer 11 of the short-circuit current shunt part 10 and the anode current collector layer 25 of the electric elements 20 may not short-circuit. That is, preferably, an insulator or the like is provided between the short-circuit current shunt part 10 and the electric elements 20, so that short circuits of the short-circuit current shunt part 10 and the electric elements 20 can be prevented even if the short-circuit current shunt part 10 is enlarged.

On the other hand, from the viewpoints that the energy density of the battery is improved more, and that short circuits of the short-circuit current shunt part 10 and the electric elements 20 as described above can be easily prevented, the short-circuit current shunt part 10 may be as small as possible. That is, in view of them, in the stacked battery 100, the outer edges of the short-circuit current shunt part 10 are preferably present on an inner side than those of the electric elements 20 when viewed in the direction of stacking the short-circuit current shunt part 10 and the electric elements 20. Alternatively, when the direction of stacking the short-circuit current shunt part 10 and the electric elements 20 is the same as that of layering the layers 21 to 25 in the electric elements 20, the outer edges of the short-circuit current shunt part 10 are preferably present on an inner side than those of the cathode material layers 22, the solid electrolyte layers 23, and the anode material layers 24 when viewed in the direction of stacking the short-circuit current shunt part 10 and the electric elements 20.

As described above, in the stacked battery 100, a rounding current from the electric elements 20 can be made to flow into the short-circuit current shunt part 10 when the short-circuit current shunt part 10 short-circuits due to nail penetration. Here, in the stacked battery 100, the first current collector layer 11 and the second current collector layer 12 of the short-circuit current shunt part 10 are formed of a predetermined metal of a high melting point, which makes it possible to prevent melt-cutting of the current collector layers 11 and 12 even when the temperature of the short-circuit current shunt part 10 becomes high due to Joule heating. Whereby, the shunt resistance of the short-circuit current shunt part 10 can be stabilized in nail penetration testing.

2. Method for Producing Stacked Battery

The short-circuit current shunt part 10 can be easily made by arranging the insulating layer 13 (for example, a thermosetting resin sheet) between the first current collector layer 11 (for example, predetermined metal foil) and the second current collector layer 12 (for example, predetermined metal foil). For example, as shown in FIGS. 2A and 2B, one may arrange the insulating layer 13 over at least one face of the second current collector layer 12, and further arrange the first current collector layer 11 over a face of the insulating layer 13 which is on the opposite side of the second current collector layer 12. Here, the layers may be stuck to each other using adhesive, resin, or the like in order to keep the shape of the short-circuit current shunt part 10. In this case, adhesive or the like is not necessary to be applied all over the faces of the layers, but may be applied to part of a surface of each layer.

The electric elements 20 can be made by a known method. For example, when an all-solid state battery is produced, one may coat the surface of the cathode current collector layer 21 with a cathode material in a wet process to be dried, to form the cathode material layer 22, coat the surface of the anode current collector layer 25 with an anode material in a wet process to be dried, to form the anode material layer 24, transfer the electrolyte layer 23 containing a solid electrolyte etc. between the cathode material layer 22 and the anode material layer 24, and integrally press-mold the layers, to make each of the electric elements 20. A pressing pressure at this time is not limited, and for example, is preferably no less than 2 ton/cm². These making procedures are just an example, and the electric elements 20 can be made by any procedures other than them as well. For example, the cathode material layer etc. can be formed by a dry process instead of a wet process.

The short-circuit current shunt part 10 made as described above is stacked onto the electric elements 20. In addition, the tab 11a provided for the first current collector layer 11 is connected with the cathode current collector layers 21, and the tab 12a provided for the second current collector layer 12 is connected with the anode current collector layers 25, which makes it possible to electrically connect the short-circuit current shunt part 10 and the electric elements 20. When a plurality of the electric elements 20 are provided, the tabs 21a of the cathode current collector layers 21 of a plurality of the electric elements 20 are connected with each other, and the tabs 25a of the anode current collector layers 25 thereof are connected with each other, which makes it possible to electrically connect a plurality of the electric elements 20 with each other in parallel. This stack of the short-circuit current shunt part 10 and the electric elements 20 formed via electric connection as described above is vacuum-sealed in an external case (battery case) of laminate film, a stainless steel can or the like, which makes it possible to make an all-solid state battery as the stacked battery. These making procedures are just an example, and an all-solid state battery can be made by any procedures other than them as well.

Alternatively, for example, one may arrange a separator instead of the solid electrolyte layer to make a stack in which electric connection is carried out as described above, and thereafter seal up the stack in an external case (battery case) that is filled with an electrolyte solution, to produce an electrolyte solution-based battery as the stacked battery as well. When an electrolyte solution based battery is produced, press-molding of the layers may be omitted.

As described above, the stacked battery 100 of the present disclosure can be easily produced by applying a conventional method for producing a battery.

3. Additional Notes

The description showed the embodiment of forming the short-circuit current shunt part of one first current collector layer, one insulating layer, and one second current collector layer. The stacked battery of the present disclosure is not restricted to this embodiment. The short-circuit current shunt part may include some insulating layer between first and second current collector layers, and the number of the layers is not specifically limited.

The description showed the embodiment of providing only one short-circuit current shunt part outside with respect to the direction of stacking a plurality of the electric elements in the stacked battery. The number of the short-circuit current shunt parts is not limited to this. A plurality of the short-circuit current shunt parts may be provided outside in the stacked battery. The position of the short-circuit current shunt part is not limited to the outside of the electric elements. The short-circuit current shunt part may be provided between a plurality of the electric elements.

The description showed such an embodiment that two electric elements share one anode current collector layer. The stacked battery of the present disclosure is not restricted to this embodiment. The electric elements may individually function as a single cell where the cathode current collector layer, the cathode material layer, the solid electrolyte layer, the anode material layer, and the anode current collector layer are layered. For example, the stacked battery of this disclosure may include such an embodiment that two electric elements share one cathode current collector layer, and may include such an embodiment that a plurality of the electric elements do not share any current collector layer, but are individually present.

The description showed the embodiment of stacking a plurality of the electric elements. A certain effect is believed to be brought about even in such an embodiment that a plurality of the electric elements are not stacked in the stacked battery (embodiment of including only one single cell). However, Joule heating due to short circuits in nail penetration etc. tends to increase more in the embodiment of stacking a plurality of the electric elements than in the embodiment of including one electric element. That is, it can be said that the effect of providing the short-circuit current shunt part is more outstanding in the embodiment of stacking a plurality of the electric elements. Thus, the stacked battery of the present disclosure preferably includes a plurality of the electric elements.

In the description, the current collector tabs protrude from the short-circuit current shunt part and the electric elements. However, the stacked battery of the present disclosure does not necessarily include the current collector tabs. For example, the current collector layers of large areas are used, outer edges of a plurality of the current collector layers are made to protrude in a stack of the short-circuit current shunt part and the electric elements, and a conducting material is held between the protruding current collector layers, which makes it possible to electrically connect the current collector layers with each other without the tabs provided. Alternatively, the current collector layers may be electrically connected with each other via conductor wires or the like instead of the tabs.

The description showed the stacked battery including both an electrolyte solution based battery, and an all-solid state battery. It is believed that the technique of the present disclosure exerts an outstanding effect when applied to an all-solid state battery where the electrolyte layer 23 is a solid electrolyte layer. Gaps in the electric elements are small, and pressure applied to the electric elements is high when a nail penetrates through the electric elements in nail penetration in an all-solid state battery compared to an electrolyte solution based battery. Thus, it is believed that the shunt resistance of the short-circuit current shunt part (and the shunt resistance of the electric elements) becomes low, and most current flows into the short-circuit current shunt part (and some electric elements). Moreover, there is a case where a constraint pressure is applied to the electric elements in an all-solid state battery in order to reduce the internal resistance in the electric elements. In this case, it is believed that a constraint pressure is applied in the direction of stacking the electric elements (direction from the cathode current collector layers toward the anode current collector layers), and in nail penetration, pressure from a nail and the constraint pressure are summed to apply to the electric elements, which makes it easy to contact the current collector layers to short-circuit, and makes it easy to lower the shunt resistance of the electric elements. Therefore, it is believed that the effect of providing the short-circuit current shunt part to shunt a rounding current is outstanding. Moreover, in an all-solid state battery, when a nail penetrates through the short-circuit current shunt part in nail penetration, pressure that applies to the short-circuit current shunt part is high as well. That is, a problem is how to properly contact the first current collector layer with the second current collector layer to lower the shunt resistance of the short-circuit current shunt part under a state where a high pressure is applied in nail penetration. In contrast, a battery case of an electrolyte solution based battery is generally filled with an electrolyte solution, the layers are immersed in the electrolyte solution, and the electrolyte solution is supplied to a gap between each layer; pressure applied by a nail in nail penetration is low compared with the case of an all-solid state battery. Therefore, the effect of providing the short-circuit current shunt part in an electrolyte solution based battery is believed to be relatively small compared to the case of an all-solid state battery. In the case of an electrolyte solution based battery, the short-circuit current shunt part may be in contact with the electrolyte solution according to the structure of the battery. In this case, metal constituting the short-circuit current shunt part may dissolve in the electrolyte solution as ions at charge/discharge potentials of electrodes. That is, there is a case where in an electrolyte solution based battery, the contact of the short-circuit current shunt part and the electrolyte solution may suppress the function of the short-circuit current shunt part. In this point, the technique of this disclosure is preferably used for an all-solid state battery as well.

When the electric elements are electrically connected with each other in series using a bipolar electrode or the like, it is believed that if a nail penetrates through some electric elements, current flows via the nail from the other electric elements to some electric elements. That is, the current flows around via the nail, which has a high contact resistance, and the flow thereof is small. When the electric elements are electrically connected with each other in series using a bipolar electrode or the like, current is believed to be the largest when a nail penetrates through all the electric elements. In this case, it is also believed that discharge of the electric elements has sufficiently progressed already, and thus, it is difficult that the temperature of some electric elements locally rises. In this point, it is believed that the effect of the short-circuit current shunt part is small compared with the case where the electric elements are electrically connected in parallel. Thus, in the stacked battery of this disclosure, the electric elements are preferably connected with each other electrically in parallel in view of exerting a more outstanding effect.

### EXAMPLES

1. Making Short-Circuit Current Shunt Part

Metal foil (15 μm in thickness) formed of metal shown in the following Table 1 was used as first and second current collector layers. Two thermosetting polyimide resin films (thickness: 25 μm, Kapton manufactured by Du Pont-Toray Co., Ltd.) were sandwiched between the first and second current collector layers as insulating layers, to be fixed with adhesive, to obtain a short-circuit current shunt part. For convenience of evaluation described later, both faces of the obtained short-circuit current shunt part were held by insulating layers.

TABLE 1

| | | Electric conductivity | Melting |
|---|---|---|---|
| | Metal | [×10⁶ S/m] | point [° C.] |
| Comp. Ex. 1 | Aluminum | 37.4 | 660 |
| Ex. 1 | Copper | 60.1 | 1085 |
| Ex. 2 | Stainless steel | 1.4 | 1400 |
| Ex. 3 | Nickel | 14.7 | 1455 |
| Ex. 4 | Iron | 10.5 | 1535 |
| Ex. 5 | Chromium | 7.8 | 1857 |
| Ex. 6 | Titanium | 1.8 | 1666 |

2. Evaluation of Stability of Shunt Resistance

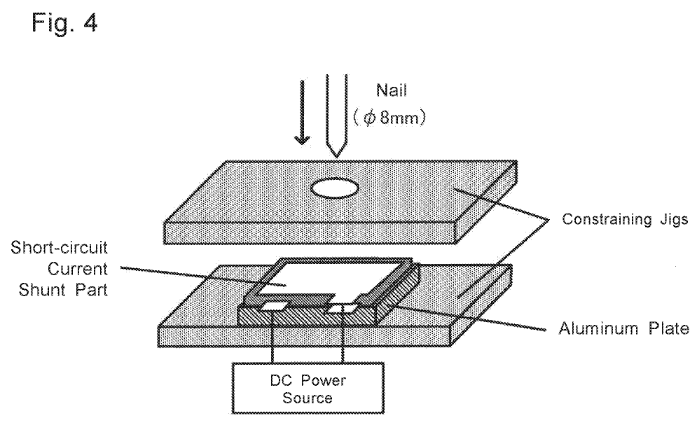

Stability of the shunt resistance of the made short-circuit current shunt part in nail penetration was evaluated by means of nail penetration testing equipment as shown in FIG. 4. Specifically, while the short-circuit current shunt part sandwiched between the insulating layers was disposed on an aluminum plate and a direct current power source was connected to tabs of the short-circuit current shunt part, both faces of the short-circuit current shunt part were constrained by constraint jigs. After the constraint, the voltage and the current of the direct current power source were set in 4.3 V and 80 A respectively. A nail (8 mm in diameter, 60 degrees in point angle) penetrated at 25 mm/sec in velocity, and change in current flowing into the short-circuit current shunt part since the start of the nail penetration until the end thereof (5 seconds after the start) was checked.

Current flowing into the short-circuit current shunt part according to Comparative Example 1, where aluminum was used as the first and second current collector layers, was unstable in a nail penetration test, and finally hardly flowed. As a result of visual inspection of a state of the short-circuit current shunt part after the nail penetration test, melt-cutting of the current collector layers occurred. That is, it is believed that the contact of the first and second current collector layers was easy to be released in the short-circuit current shunt part of Comparative Example 1 due to the melt-cutting caused by Joule heating in the nail penetration test, which made the shunt resistance unstable.

In contrast, current was able to flow stably into the short-circuit current shunt parts according to Examples 1 to 6, where predetermined metals of a high melting point were used as the first and second current collector layers, in the nail penetration tests. No melt-cutting was observed even when the states of the short-circuit current shunt parts were visually inspected after the nail penetration tests.

3. Additional Experiment

3.1. Making Short-Circuit Current Shunt Part

### Examples 7 to 11 and Comparative Examples 2 to 5

A short-circuit current shunt part was obtained in the same manner as in Example 1 except that copper foil (1N30 manufactured by Fukuda Metal Foil & Powder Co., Ltd.) or aluminum foil (1N30) shown in the following Table 2 was used as the first current collector layer, and copper foil (1N30 manufactured by Fukuda Metal Foil & Powder Co., Ltd.) shown in the following Table 2 was used as the second current collector layer. Here, in Example 8, a plurality of sheets of copper foil were layered in the first and second current collector layers. In Examples 9 to 11, a plurality of sheets of copper foil were layered in the first current collector layers. In Comparative Examples 3 to 5, a plurality of sheets of aluminum foil were layered in the first current collector layers.

TABLE 2

| | First current collector layer | | | | Second current collector layer | | | |
|---|---|---|---|---|---|---|---|---|
| | | Thickness | Number | Total | | Thickness | Number | Total |
| | | of foil | of sheets | thickness | | of foil | of sheets | thickness |
| | Foil | (μm) | of foil | (μm) | Foil | (μm) | of foil | (μm) |
| Ex. 7 | Cu foil | 35 | 1 | 35 | Cu foil | 35 | 1 | 35 |
| Ex. 8 | Cu foil | 10 | 3 | 30 | Cu foil | 10 | 3 | 30 |
| Ex. 9 | Cu foil | 10 | 4 | 40 | Cu foil | 35 | 1 | 35 |
| Ex. 10 | Cu foil | 10 | 6 | 60 | Cu foil | 35 | 1 | 35 |
| Ex. 11 | Cu foil | 10 | 7 | 70 | Cu foil | 35 | 1 | 35 |
| Comp. Ex. 2 | Al foil | 100 | 1 | 100 | Cu foil | 35 | 1 | 35 |
| Comp. Ex. 3 | Al foil | 8 | 16 | 128 | Cu foil | 35 | 1 | 35 |
| Comp. Ex. 4 | Al foil | 15 | 3 | 45 | Cu foil | 35 | 1 | 35 |
| Comp. Ex. 5 | Al foil | 15 | 2 | 30 | Cu foil | 35 | 1 | 35 |

3.2. Evaluation of Stability of Shunt Resistance

The short-circuit current shunt parts of Examples 7 and 8, and Comparative Examples 2 to 5 were subjected to nail penetration testing according to the above described way (it is noted that the direct current power source was set in 4.3 V in voltage and 245 A in current) by means of nail penetration testing equipment as shown in FIG. 4. The direction of nail penetration was a direction from the first current collector layers via the insulating layers toward the second current collector layers (that is, the first current collector layers were arranged on a side from which a nail penetrated). Stability of the shunt resistance of the short-circuit current shunt parts in nail penetration was evaluated, and the mean values of current (mean current) flowing into the short-circuit current shunt parts in nail penetration were obtained. A larger mean current can be said to be preferable. The results are shown in the following Table 3.

TABLE 3

| | Stability of shunt resistance | Mean current (A) |
|---|---|---|
| Ex. 7 | Stable | 191 |
| Ex. 8 | Stable | 197 |
| Ex. 9 | Stable | 207 |
| Ex. 10 | Stable | 213 |
| Ex. 11 | Stable | 216 |
| Comp. Ex. 2 | Current temporarily flowed | 38 |
| Comp. Ex. 3 | Current temporarily flowed | 53 |
| Comp. Ex. 4 | Current temporarily flowed | 116 |
| Comp. Ex. 5 | Current temporarily flowed | 53 |

As is apparent from the results shown in Table 3, the mean value of current flowing into each of the short-circuit current shunt parts of Examples 7 to 11, where copper foil was used as the first current collector layer, in nail penetration was larger than that of Comparative Examples 2 to 5, where aluminum foil was used as the first current collector layer, and the short-circuit current shunt parts of Examples 7 to 11 more stably short-circuited than those of Comparative Examples 2 to 5 in nail penetration. It is believed that in Examples 7 to 11, copper, which is metal of a high melting point, was employed for metal constituting the first current collector layers, which made it possible to prevent melt-cutting of the first current collector layers in the nail penetration tests, and as a result, stability of the contact of the first and second current collector layers in the short-circuit current shunt parts was improved. This effect is exerted when metal of a high melting point, other than copper, is used as well. However, according to the findings of the inventors of this disclosure, especially when metal constituting the first and second current collector layers is copper as Examples 7 to 11, the short-circuit current shunt part can be especially stably short-circuited in nail penetration testing, and the shunt resistance can be specifically lowered.

From the results of Examples 7 to 11 and Comparative Examples 2 to 5, it was found that in order to improve the contact property of the first and second current collector layers in nail penetration of the short-circuit current shunt part to make the shunt resistance of the short-circuit current shunt part lower, at least one of the first and second current collector layers (especially a current collector layer present on a side from which a nail penetrates in nail penetration testing) is preferably formed of a plurality of sheets of metal foil. Specifically, as Example 8, both the first and second current collector layers are further preferably formed of a plurality of sheets of metal foil.

Examples 1 to 11 showed an example of making the first and second current collector layers from the same metal. When the first and second current collector layers are made from different metals, a desired effect can be exerted as well as long as melt-cutting as described above can be prevented. That is, it can be said that a desired effect can be exerted when the first and second current collector layers consist of at least one metal selected from the group consisting of copper, stainless steel, nickel, iron, chromium, and titanium.

As described above, it is apparent that when the short-circuit current shunt part is provided together with the electric elements in the stacked battery, using a predetermined metal of a high melting point for a current collector layer that is a component of the short-circuit current shunt part makes it possible to prevent melt-cutting of the current collector layers in nail penetration testing, keep the shunt resistance of the short-circuit current shunt part low, and properly shunt a rounding current from the electric elements to the short-circuit current shunt part.

### INDUSTRIAL APPLICABILITY

The stacked battery according to this disclosure can be preferably used in a wide range of power sources such as a small-sized power source for portable devices and an onboard large-sized power source.

### REFERENCE SIGNS LIST

10 short-circuit current shunt part
11 first current collector layer (a plurality of sheets of metal foil)
11a first current collector tab
12 second current collector layer
12a second current collector tab
13 insulating layer
20a, 20b electric element
21 cathode current collector layer
21a cathode current collector tab
22 cathode material layer
23 electrolyte layer
24 anode material layer
25 anode current collector layer
25a anode current collector tab
100 stacked battery

What is claimed is:

1. A stacked battery comprising:
at least one short-circuit current shunt part; and
at least one electric element, the short-circuit current shunt part and the electric element being stacked, wherein
the short-circuit current shunt part comprises a first current collector layer, a second current collector layer, and an insulating layer provided between the first and second current collector layers, all of these layers being layered,
the electric element comprises a cathode current collector layer, a cathode material layer, an electrolyte layer, an anode material layer, and an anode current collector layer, all of these layers being layered,
the first current collector layer is electrically connected with the cathode current collector layer,
the second current collector layer is electrically connected with the anode current collector layer, and
each of the first and second current collector layers consists of at least one metal selected from the group consisting of copper, stainless steel, nickel, iron, chromium, and titanium.

2. The stacked battery according to claim 1, further comprising:
an external case that stores the short-circuit current shunt part and the electric element,
wherein the short-circuit current shunt part is provided between the electric element and the external case.

3. The stacked battery according to claim 1, wherein a plurality of the electric elements are electrically connected with each other in parallel.

4. The stacked battery according to claim 1, wherein the following directions are the same:
a direction of layering the cathode current collector layer, the cathode material layer, the electrolyte layer, the anode material layer, and the anode current collector layer in the electric element;
a direction of layering the first current collector layer, the insulating layer, and the second current collector layer in the short-circuit current shunt part; and
a direction of stacking the short-circuit current shunt part and the electric element.

5. The stacked battery according to claim 1, wherein the electrolyte layer is a solid electrolyte layer.

6. The stacked battery according to claim 1, wherein each of the first and second current collector layers consists of copper.

7. The stacked battery according to claim 1, wherein
the cathode current collector layer consists of aluminum, and
the anode current collector layer consists of copper.

8. The stacked battery according to claim 1, wherein at least one of the first and second current collector layers consists of a plurality of sheets of metal foil.

9. The stacked battery according to claim 8, wherein the metal foil is copper foil.
